(19) United States
(12) Patent Application Publication
(10) Pub. No.: US 2004/0061942 A1
(43) Pub. Date: Apr. 1, 2004

(54) Dielectric-based variable angle optical attenuation filter

(76) Inventor: Jami Knapp, Mendon, MA (US)

Correspondence Address: Peter F. Corless, Esq., EDWARDS & ANGELL, LLP, P.O. Box 9169, Boston, MA, 02209, US

(21) Appl. No.: 10/651,505

(22) Filed: Aug. 29, 2003

Related U.S. Application Data
(60) Provisional application No. 60/414,755, filed on Sep. 30, 2002.

(51) Int. Cl. G02B 1/10

(52) U.S. Cl. 359/580

(57) ABSTRACT

An optical attenuation filter is provided wherein a coating is deposited or otherwise introduced onto a substrate. The coating can be comprised of one or more layers, each of which can include one or more materials, such as dielectric materials. The optical attenuation filter is capable of providing variable, yet accurate attenuation incident light from a light source without the drawbacks associated with metal-film-based conventional attenuation filters.

### CROSS REFERENCE TO RELATED APPLICATIONS

This application claims priority from, and incorporates by reference the entirety of U.S. Provisional Patent Application No. 60/414,755, which was filed on Sep. 30, 2002, and which is currently pending.

### FIELD OF THE INVENTION

The present invention relates to optical filters, and, more particularly, to optical filters that are coated with one or more dielectric materials and that are capable of providing variable attenuation of the output of a light source.

### BACKGROUND OF THE INVENTION

Monochromatic and polychromatic light sources (e.g. lasers, light emitting diodes, mercury arc-lamps, filtered halogen or xenon sources, etc.) are routinely utilized in many leading industries (e.g., telecommunications, medicine, spectrometry) and are vital components in numerous important devices (e.g., process control equipment, optical instrumentation).

Although it is always important to maintain accurate control of light sources, it is especially desired to precisely control certain aspects of light sources in connection with certain end use applications. For example, it is a crucial to obtain/maintain accurate output intensity tuning of monochromatic or polychromatic light sources in connection with certain biomedical and optical instrument applications. In such applications (and others), it is not unheard of to require as low as 0.1% attenuation of the output of an incident light source from its original output intensity, which was near 100%.

At present, a desired level of attenuation control is achieved through the use of neutral density attenuation filters that are coated with a variable thickness, metal-film based coating. Exemplary such filters are coated with, e.g., aluminum, silver, NiCr, or alloys sold under the Inconel® name. It is known that the level of attenuation provided/exhibited by such filters will vary depending on the thickness of the metal-film-based coating, and that such filters provide/exhibit less attenuation at areas of the filter that are thinly coated as compared to areas of the filter that are thickly coated.

FIGS. 1 and 2 depict a disk-shaped attenuation filter 10 known in the art. The filter 10 includes a substrate 20 on which there has been introduced a metal-film-based coating 30, and wherein the thickness of the coating varies over the circumference of the disk-shaped filter—that is, the disk shaped filter has a circularly-variable coating thickness. The variation in the thickness of the coating 30 is represented in FIG. 1 by the varying shade of the coating, wherein the coating is more darkly shaded near the thicker area 30A of coating, and more lightly shaded near the thinner area 30B of coating.

It is also known to design rectangular-shaped, metal-film-based attenuation filters (not shown) that likewise include coatings with varying thicknesses. In such filters, the thickness of the coating is linearly-variable—that is, the coating thickness varies over the length and/or width of the filter.

By varying (i.e., grading) the physical thickness of the coating 30 of the metal-film-based filter 10, accurate attenuation adjustments can be made. For example, in use, the filter 10 is sited after a light source 40, as shown in FIG. 2. When the disk shaped-filter 10 is spun about its horizontal axis (in the direction of arrow 50 in FIG. 1), it will attenuate—by a combination of optical absorption, scatter and reflection—varying amounts of output (i.e., light, irradiance) from the light source 40 due to the varying thickness of the coating 30. For a linearly-variable, metal-film based filter, varied attenuation is achieved by moving the filter about its horizontal axis in a widthwise and/or lengthwise direction.

FIG. 3 depicts a graph representing the theoretical performance of the disk shaped filter 10 of FIGS. 1 and 2 when exposed to a light source 40. Specifically, the graph represents the variation—in the percentage transmittance versus the variation of the angle between the filter 10 and the light source 40—that occurs when the filter 10 is spun about its horizontal axis, e.g., as shown in FIG. 1.

The area of lowest percentage transmittance corresponds to instances wherein the output of the light source 40 is impinging upon the portions of the filter 10 that have the thickest coating 30A. Because the coating 30 is thick at these portions 30A, the filter 10 attenuates more (i.e., transmits less) of the output of the light source 40. As the filter 10 is spun about its horizontal axis in the direction of arrow 50, the output of the light source 40 impinges upon portions of the filter that have reduced thicknesses, and, in turn, progressively less of the light source output is attenuated (i.e., a higher percentage of the output is transmitted) by the filter.

The linear relationship depicted in the graph of FIG. 3 between the percentage transmittance and the angle that is defined between the filter 10 and the light source 40 demonstrates that accurate adjustments to the transmittance/attenuation of a light source can be made by spinning of the metal-film-based filter 10 of FIGS. 1 and 2 about its horizontal axis.

However, although such filters 10 can be utilized to accurately attenuate light source output they also suffer from several notable disadvantages owing to their metal-film-based composition. For example, metal-based filters are quite costly (i.e., $360 for a 100 mm diameter 3 OD variable attenuator); plus, they suffer from severe autofluorescence, which, in turn, restricts or severely limits their use in sensitive biomedical applications (e.g., blood testing, hormone testing).

Metal-based filters also tend to significantly degrade when exposed to intense UV light, are quite large in size (i.e., ≧30 mm in diameter), can typically be effectively used in a limited range of temperature environments (i.e., those less than 250° C.), and have limited longevity due to environmental sensitivity and susceptibility of the metal-based material. Also, such filters exhibit poor abrasion resistance, have a high occurrence of pinholes and/or voids, and tend to experience significant light scatter.

Therefore, a need exists for a novel optical attenuation filter that provides the highly accurate, variable attenuation that is crucial in certain monochromatic and polychromatic light source applications, yet that also does not suffer from the disadvantages that plague conventional metal-film-based attenuation filters.

### SUMMARY OF THE INVENTION

The present invention meets this and other needs by providing an optical attenuation filter that is coated with one or more dielectric materials, rather than metal-based materials. The dielectric coating allows the optical attenuation filter of the present invention to provide all of the benefits of conventional filters that are coated with metal-based films, without suffering from the numerous drawbacks associated with such metal-film-based filters.

Whereas conventional metal-film-based filters attenuate the output (i.e., light, irradiance) of a light source via a combination of optical absorption, scatter and reflection, the presence of the dielectric coating allows optical attenuation filters of the present invention to achieve attenuation entirely or almost entirely by reflectance (via optical interference), and without absorption and scatter. This, in turn, allows an optical attenuation filter of the present invention to perform in critical applications (e.g., medical testing) that require negligible autofluorescence.

And whereas conventional filters are replete with problems and drawbacks due to their metal-based composition, the dielectic-based composition of filters in accordance with the present invention provides numerous significant benefits relating to cost, size, durability, longevity and applicability to high temperature usage environments. The dielectric-based composition also provides improved abrasion resistance, exhibits negligible occurrence of light scatter, pinholes and/or voids, exhibits minimal autofluorescence, and demonstrates excellent resistance to environmental effects.

According to an exemplary aspect of the present invention, a filter is comprised of a substrate that has been coated with one or more dielectric materials. According to a currently preferred aspect of the present invention, the coating is comprised of a plurality of layers, wherein each coating layer is itself comprised of one or more identical, similar or different dielectric materials.

The thickness of the coating layers (and, thus, the entire coating) will vary depending on, e.g., the envisioned usage application(s) for the filter. According to an exemplary aspect of the present invention, each layer of the coating will have a thickness between about 1 nm and 1000 nm.

The substrate on which the coating is deposited can be made of a wide range of materials, but it is currently preferred that the substrate be made of a transparent glass or glass-like material. Many processes can be utilized to coat the substrate with the dielectric material(s); however, coating processes that yield stable, environmentally invariant coatings are currently preferred. Once the coating has been deposited or otherwise introduced onto a substrate, the coating can be sealed to render the filter less susceptible to environmental degradation.

An optical attenuation filter according to the present invention is readily capable of providing accurately varied attenuation of the output of a light source. By way of non-limiting example, the filter can be mounted upon a device to allow the filter to rotate about the filter's vertical axis. As the filter is rotated, the angle between the filter and the output of the light source will vary, thus, in turn, varying the level of attenuation of the output (i.e., light or irradiance) of the filter.

It is currently preferred that the coating comprise at least two different dielectric materials because, for example, the different materials would have different angle dependent refractive indices, thus providing for accurate yet varying (i.e., angle dependent) attenuation of the output of a light source by reflectance as the filter is rotated about its vertical axis.

### BRIEF DESCRIPTION OF THE DRAWINGS

For a fuller understanding of the nature and desired objects of the present invention, reference is made to the following detailed description, which is to be taken in conjunction with the accompanying drawing figures wherein like reference characters denote corresponding parts throughout the several views presented within the drawing figures, and wherein:

FIG. 1 is a front view of a prior art optical attenuation filter;

FIG. 2 is a side view of the optical attenuation filter of FIG. 1 in an exemplary usage environment;

FIG. 3 is a graph of the theoretical percentage transmittance versus angle of rotation of the optical attenuation filter of FIGS. 1 and 2;

FIG. 4 depicts a side view of an optical attenuation filter in accordance with the present invention;

FIG. 5 is a front view of the optical attenuation filter of FIG. 4 in an exemplary usage environment;

FIG. 6 is a graph of a desired relationship between the percentage transmittance and the angle of rotation of an optical attenuation filter of the present invention;

FIGS. 7-11 are graphs of the observed percentage transmittance versus wavelength at certain angles for an exemplary optical attenuation filter of the present invention; and

FIG. 12 is a graph of the measured percentage transmittance versus angle of rotation for an exemplary optical attenuation filter of the present invention.

### DETAILED DESCTRIPTION OF THE INVENTION

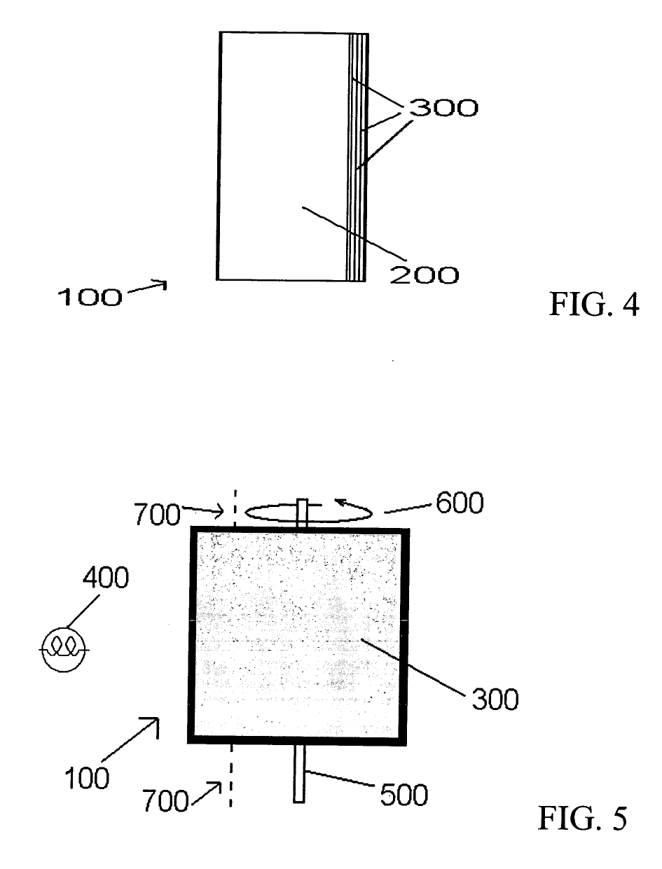

Referring initially to FIG. 4, an optical attenuation filter 100 of the present invention is shown. The filter 100 is comprised of a substrate 200 on which a coating 300 has been deposited or otherwise introduced.

The substrate 200 can have a wide range of shapes (e.g., square, as shown in FIGS. 4 and 5) and can be made of a wide range of materials known in the art. According to a currently preferred embodiment of the present invention, the substrate is made of a transparent glass or glass-like material. Examples of suitable materials from which the substrate 200 can be constructed include, but are not limited to, fused silica, borosilicate, BK7, soda-lime glass, and crown glass.

Generally, but not necessarily, the coating is comprised of a plurality of separate layers 300 (see FIG. 4). The exact number of layers can vary depending on the material(s) that comprise the coating 300, as well as for what purpose and/or under what conditions the filter 100 will be used. By way of non-limiting example, the number of coating layers 300 can be in the range of one to one hundred. According to currently preferred embodiments of the present invention, the number of coating layers 300 is in the range of two to fifty.

One, some or all of the coating layer(s) 300 can be can be comprised of one material, or a plurality of materials. The number and/or type of material(s) that comprise(s) each coating layer 300 may be identical, similar, or different.

For example, one or more coating layers 300 can be comprised of solely one material, whereas one or more other layers may be comprised of a plurality of materials. In an embodiment wherein one coating layer 300 is comprised solely of one material (e.g., material A), one, some or all of the other coating layers can be comprised of the same one material (i.e., material A) or of one or more different materials (e.g., material B, or material A and material B, or material B and material C, etc.). Also, in an embodiment wherein one coating layer 300 is comprised of more than one different material (e.g., material A and material B), one, some or all of the other coating layers can be comprised of the same combination of materials (i.e., material A and material B) or of different combination of materials (e.g., material A and material C, or material B and material C, or material A and material B and material C, or material B and material D, etc.).

In an embodiment wherein the filter 100 is comprised of at least one coating layer 300 that includes a combination of different materials (e.g., material A and materials B), it is currently preferred that some or all of those different materials have different indices of refraction. This enables or facilitates the ability of the filter 100 to provide accurate yet variable attenuation of the output of a light source 400 depending on the angle at which the output (i.e., light or irradiance) impinges upon the filter.

In accordance with the present invention, at least one coating layer 300 includes one or more dielectric materials. Moreover, in an embodiment in which the filter 100 includes only one coating layer 300, it is currently preferred that the single layer include one or more dielectric materials.

Exemplary dielectric materials that can form all or a portion of any or all coating layer(s) 300 of the filter 100 include, but are not limited to, one or more oxide materials (e.g., silicon dioxide, tantalum pentoxide, titanium dioxide, aluminum oxide), one or more non-oxide materials (e.g., zinc sulfide, zinc selenide, cryolite (Na₃AlF₆), lead fluoride, thorium fluoride, magnesium fluoride), one or more glasses, one or more ceramics, and one or more polymers.

In an embodiment of the present invention in which at least one coating layer 300 of the filter 100 is comprised of one or more dielectric materials, it is currently preferred that at least one oxide material comprises at least a portion of at least one coating layer. According to a currently more preferred embodiment, at least two different oxide materials comprise at least one coating layer 300.

In an embodiment wherein one or more coating layers 300 are comprised of more than one dielectric material, it is currently preferred that such layer(s) comprise at least two dielectric materials with different indices of refraction. In such an embodiment, the indices of refraction generally, but not necessarily, will differ by an amount in the range of about 0.5 to 1.5 and will have a ratio in the range of about 1.0 to 2.0, wherein a difference in amount in the range of about 0.5 to 1.0 and a ratio in the range of about 1.25 to 1.85 are currently preferred.

The thickness of each coating layer 300 (and, thus, the entire coating itself) will vary depending on such factors as the envisioned application(s) and usage environment(s) for the filter 100, the type of light source 400, etc. According to an exemplary embodiment of the present invention, the total thickness of the coating layers 300 will be in the range of about 1 nm and 1000 nm. The thickness of the coating 300 may vary from layer to layer and/or within one or more layers, e.g., in order to influence the level of attenuation provided by the filter 100.

Each layer that comprises the coating 300 will have a thickness in the range of about 0.1% to 100% of the total thickness of the coating layers. According to an exemplary embodiment of the present invention, each coating layer 300 will have a thickness in the range of about 1 nm to about 500 nm, with a per layer thickness range of about 10 nm to about 200 nm being currently preferred.

Many conventional coating processes known to those of ordinary skill in the art can be utilized to introduce/deposit the coating layer(s) 300 onto the substrate 200 to form the filter 100. Currently, deposition processes that produce stable, environmentally invariant coatings are preferred, wherein such processes can include, but are not limited to, chemical vapor deposition, physical vapor deposition (e.g., thermal evaporation through the use of electron-beam technology), ion assisted deposition, ion beam or magnetic sputtering, and reactive ion plating.

Exemplary coating deposition techniques that may be utilized in connection with the present invention also are described in U.S. Pat. No. 5,753,319 to Knapp et al., the content of which is incorporated by reference in its entirety.

It should be understood that in an embodiment of the present invention in which multiple coating layers 300 are introduced/deposited onto the substrate 200 in order to form the filter 100, it is possible to utilize different processes to introduce/deposit some or all of the various coating layers; however, it is currently preferred to utilize the same process to introduce/deposit all of the coating layer(s) onto the substrate.

Once the coating layer(s) 300 has/have been applied, the layer(s) can be sealed (e.g., hermetically sealed) with a sealant as is generally known in the art, and/or the layers(s) can be otherwise treated in order to render the coating (and, thus, the filter as well) less susceptible to environmental degradation.

In use, the filter 100 is placed in proximity of a light source 400, wherein the exact distance between the filter and the light source will be known to one of ordinary skill in the art and can depend on, e.g., the light source being used, the chosen application for the filter, etc. The angle between the filter 100 and the light source 400 is then varied in order to vary the amount of incident light/irradiance outputted from the light source that is attenuated by the filter.

Various techniques and arrangements can be employed in order to vary the angle between the filter 100 and the light source 400. According to an exemplary embodiment of the present invention, and as is depicted in FIG. 5, the filter 100 can be mounted or otherwise placed into communication with an object or device, e.g., a mounting frame 500.

The filter 100 should be mounted to the frame 500 such that the angle between the filter and the output (i.e., light or irradiance) of the light source 400 can be readily, yet accurately varied and such that the output of the light source will impinge upon different portions of the coating 300 as the angle is being varied.

According to a currently preferred embodiment of the present invention, and as depicted in FIG. 5, the filter 100 is mounted to the mounting frame 500 to allow for rotation of the filter in the direction indicated by arrow 600—that is, to allow for rotation of the filter about/around the filter's vertical axis 700.

It should be understood that variation of the angle between the filter 100 and the output of the light source 400 can be accomplished via other known techniques. It should be further understood that the filter 100 can be mounted to the frame 500 differently than as depicted in FIG. 5, or can be placed into communication with other objects/devices that likewise allow for or facilitate variation (e.g., by rotating the filter about its vertical axis 700) of the angle between the filter and the output of the light source 400.

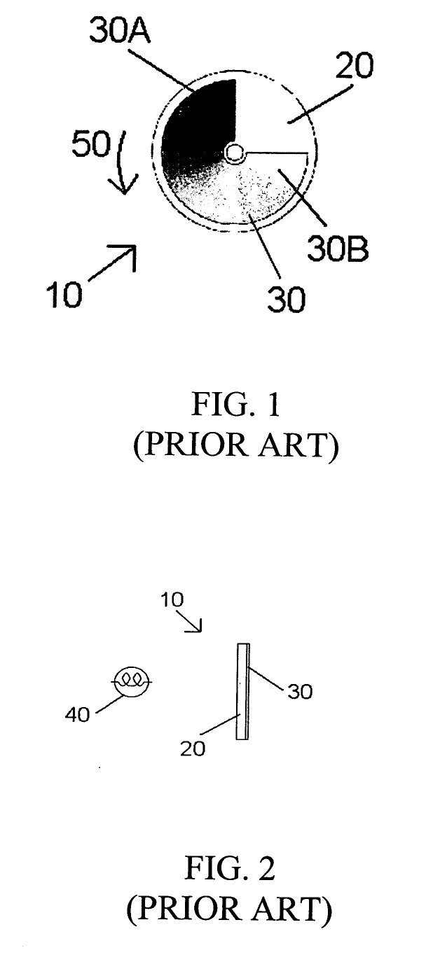

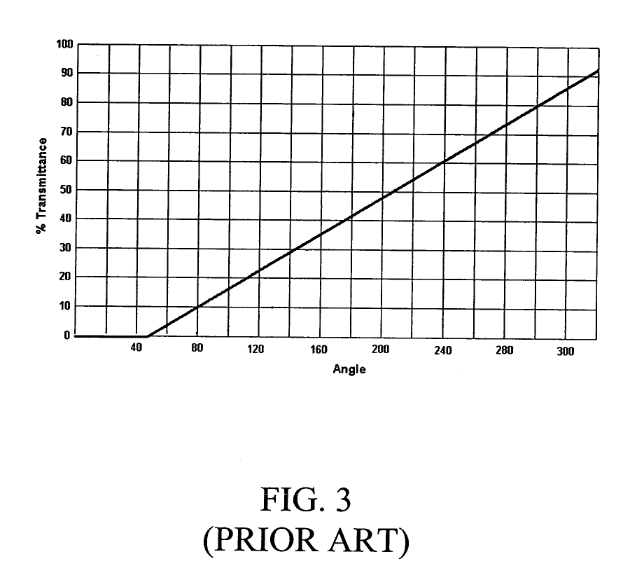

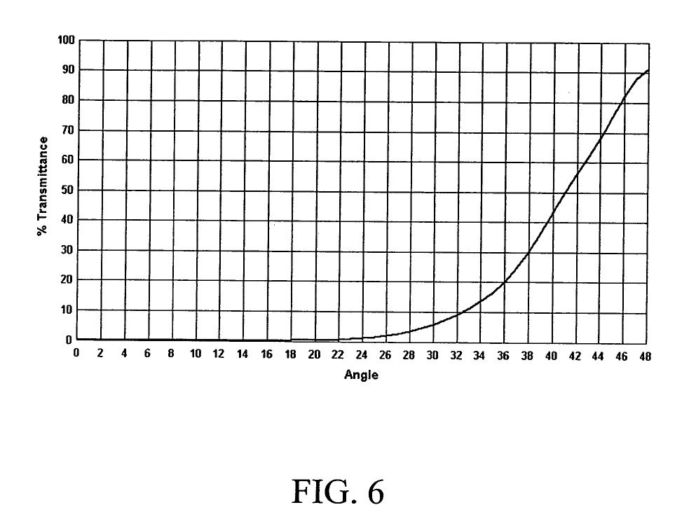

As noted above, the graph of FIG. 3 depicts a theoretical relationship between the percentage transmittance versus the angle variation between a metal-film-based filter 10 (see FIGS. 1 and 2) and the output of a light source 40. For the arrangement of FIG. 5, and for like arrangements, the desired relationship (as depicted in FIG. 6) between percentage transmittance versus the angle variation between a filter 100 and the output of a light source 400 is similar to that depicted in the graph of FIG. 3.

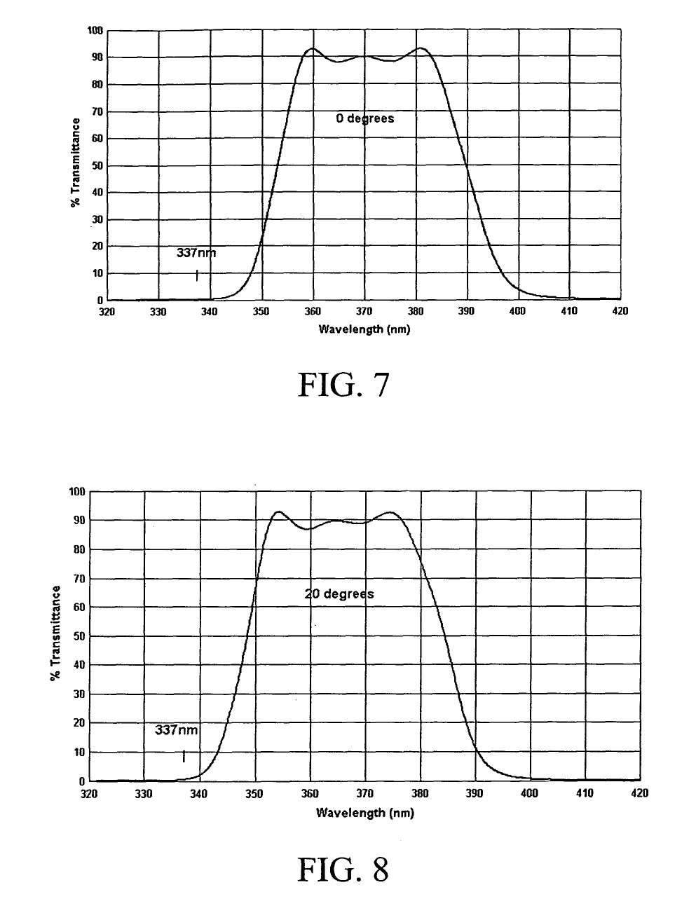

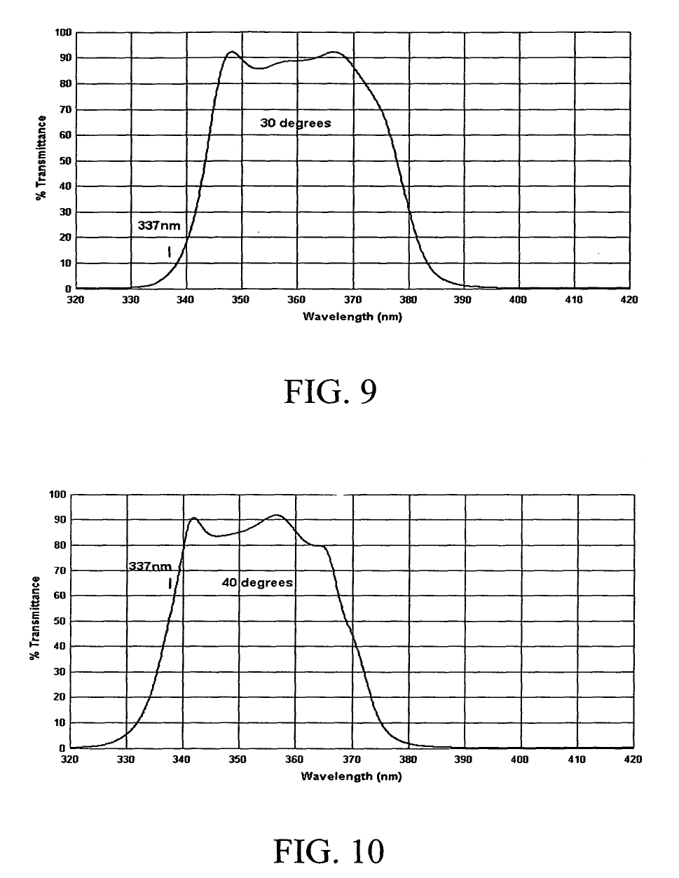

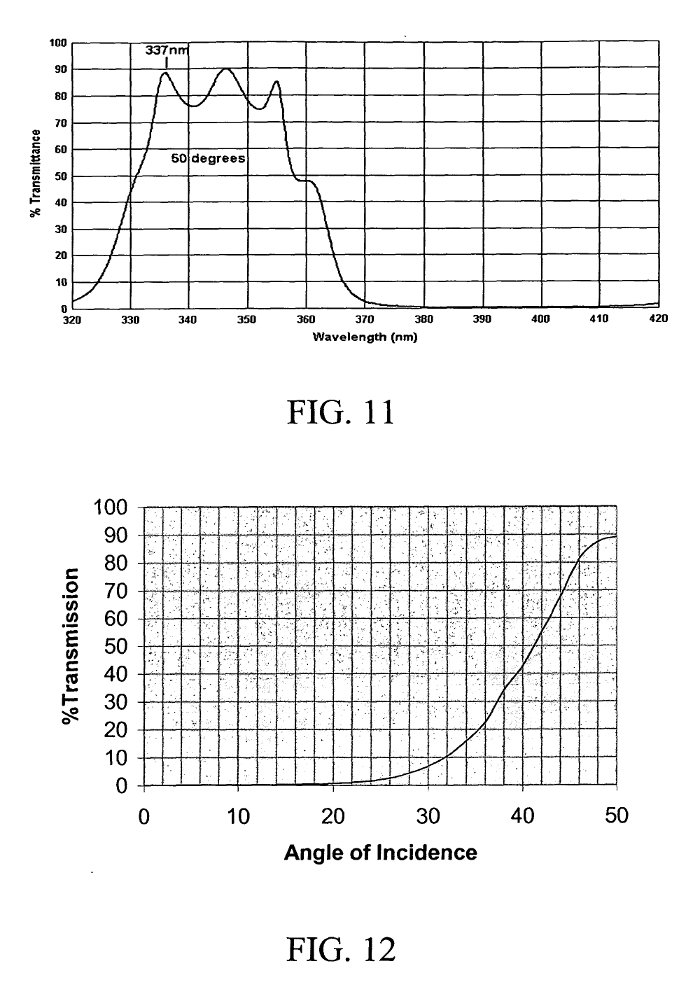

As shown in the graphs of FIGS. 7-12 and in accordance with the EXAMPLE below, the filter 100 arrangement of FIGS. 4 and 5 is capable of achieving the desired FIG. 6 graphical relationship between the percentage transmittance versus the angle variation between a filter and the output of a light source 400.

### EXAMPLE

An attenuation filter according to the present invention was produced by depositing (via plasma assisted magnetron sputtering) a thirty-layer coating of silicon dioxide and tantalum pentoxide atop a 1.1 mm thick borosilicate substrate.

The layers of the thirty-layer coating were deposited such that the filter was arranged as follows:

SUBSTRATE/(0.25H 0.5L 0.25H 0.25L)² (0.25H 0.25L 0.5H 0.25L 0.25H 0.25L)³ (0.25H 0.5L 0.25H 0.25L)/AIR

H=Ta₂O₅ (index of refraction=2.07)

L=SiO₂ (index of refraction of 1.46)

0.25H=one quarter wave thickness layer of Ta₂O₅

0.5H=one half wave thickness layer of Ta₂O₅

0.25L=one quarter wave thickness layer of SiO₂

0.5L=one half wave thickness layer of SiO₂

In this EXAMPLE, (0.25H 0.5L 0.25H 0.25L)² refers to the eight layers that are deposited directly atop the substrate, wherein the superscript “2” after the (0.25H 0.5L 0.25H 0.25L) denotes that this four layer arrangement is repeated immediately atop the fourth layer of the coating. Thus, (0.25H 0.25L 0.5H 0.25L 0.25H 0.25L)³ refers to the eighteen layers (i.e., layers nine through twenty-six) that are placed above the eighth layer of the coating. The final four coating layers (i.e., layers twenty-seven through thirty) are comprised of (0.25H 0.5L 0.25H 0.25L), which is an identical arrangement as the first four layers and layers five though nine.

Thus, the coating of the EXAMPLE filter is comprised of alternating layers of tantalum pentoxide (“H”—which comprise the odd-numbered layers, i.e., layers 1, 3, 5, 7, 9 . . . 29) and silicon dioxide (“L”—which comprise the even-numbered layers, i.e., 2, 4, 6, 8, 10 . . . 30), wherein the thickness of each specific layer in the EXAMPLE is as indicated below in Table I.

TABLE I

| | | Corresponding layers (wherein the layer immediately atop |
|---|---|---|
| Layer | | the substrate is layer 1, and the layer exposed to air is layer |
| thickness | | 30) in which thickness is present |
| .25 | H | 1, 3, 5, 7, 9, 13, 15, 19, 21, 25, 27, 29 |
| .25 | L | 4, 8, 10, 12, 14, 16, 18, 20, 22, 24, 26, 30 |
| .5 | H | 11, 17, 23 |
| .5 | L | 2, 6, 28 |

It should be understood that the arrangement and/or the layer thickness of the coating layers may differ in accordance with this EXAMPLE. Moreover, the arrangement and/or thickness of the coating layers for other filters in accordance with the present invention may differ (e.g., regarding the number of total layers, the arrangement of layers, the compositions of the layers, etc.) from those of the EXAMPLE without departing from the scope of the present invention

The design wavelength of the filter in this EXAMPLE is 369.7 nm; thus, the filter can perform at a chosen wavelength (e.g., at 337 nm) in connection with a chosen application (e.g., wherein the light source is an intense nitrogen laser). It is understood; however, that this filter (and others in accordance with the present invention) can be used with other light sources. FIGS. 7-11 depict spectral behavior as a function of wavelength for various angles of incident light. When the angle of incidence increases, the spectral behavior of the filter shifts toward shorter wavelengths. And at 337 nm wavelength, the effect is a controllable change in percentage transmittance versus the angle defined between the filter and the output (i.e., incident light or irradiance) of the intense nitrogen laser, as shown by the graph in FIG. 12.

Scrutiny of FIG. 12 reveals that it mimics the desired performance depicted in FIG. 6, which, as noted above, is very similar to the theoretical performance (as indicated by the graph in FIG. 3) of a conventional metal-film-based attenuation filters, such as the filter 10 depicted in FIGS. 1 and 2. But, as can be seen from Table II below, an attenuation filter of the present invention (e.g., the attenuation filter described in the EXAMPLE) can exhibit this desired performance without suffering from any of the disadvantages that plague metal-film-based filters.

TABLE II

| | Filter coated with | |
|---|---|---|
| | dielectric | Filter coated with one |
| | material(s) (in | or more metal-based |
| | accordance with | materials (in accor- |
| | present invention) | dance with prior art) |
| COST | <$10 each | $360 each* |
| AUTOFLUORESCENCE | Minimal | Severe |
| SIZE | As small as 1 mm | Typically >30 mm |
| | | diameter |
| BEHAVIOR WHEN | No Negative | Significant |
| EXPOSED TO UV LIGHT | Effects | Degradation |
| APPLICABLE | >400° C. | Typically <250° C. |
| TEMPERATURE RANGE | | |
| ABRASION RESISTANCE | Excellent | Poor |
| OCCURRENCE OF | Negligible | Non-negligible |
| PINHOLES/VOIDS | | |
| LIGHT SCATTER | Negligible | Significant |
| EFFECTS OF | Does not affect | Limited lifetime due to |
| ENVIRONMENTAL | lifetime of filter | environmental effects |
| EXPOSURE | | |

*= for a 100 nm diameter 3 OD variable attenuator

Regarding the effects of environmental exposure, a filter as described in the above EXAMPLE was tested according to the MIL-STD-810E military tests and another filter as described in the above EXAMPLE was tested in accordance with the snap-cellophane military test of MIL-C-48497. In both instances, the coatings of the filter maintained excellent adherence to the substrate and did not undergo significant degradation, despite the demanding rigors of the test processes.

Another advantage of the filters of the present invention is that whereas conventional filters attenuate the output of a light source via a combination of optical absorption, scatter and reflection, the presence of a partially or completely dielectric-based coating allows filters of the present invention to achieve attenuation entirely or almost entirely by reflectance, and without absorption and scatter. This, in turn, allows the attenuation filter of the present invention to perform in critical applications (e.g., medical testing) requiring minimal autofluorescence.

Although the present invention has been described herein with reference to specific details of currently preferred embodiments thereof, it is not intended that such details should be regarded as limiting the scope of the invention, except as and to the extent that they are included in the accompanying claims—that is, the foregoing description of the invention is merely illustrative thereof, and it should be understood that variations and modifications can be effected without departing from the scope or spirit of the invention as set forth in the following claims. Moreover, any document(s) mentioned herein are incorporated by reference in their entirety, as are any other documents that are referenced within the document(s) mentioned herein.

What is claimed is:

1. An optical attenuation filter, comprising:
a substrate; and
a coating having at least one layer, the coating including at least one dielectric material such that the optical attenuation filter is capable of attenuating incident light via reflectance.

2. The optical attenuation filter of claim 1, wherein the coating includes at least two different dielectric materials.

3. The optical attenuation filter of claim 2, wherein the coating includes a plurality of layers, and wherein at least a first of the plurality of layers includes a first dielectric material, and wherein at least a second of the plurality of layers includes a second dielectric material that is different than the first dielectric material.

4. The optical attenuation filter of claim 2, wherein the different dielectric materials have different indices of refraction, and wherein the indices of refraction differ by a predetermined amount and have a predetermined ratio such that the optical attenuation filter is capable of attenuating a varying amount of incident light based on variation of an angle between the optical attenuation filter and the incident light.

5. The optical attenuation filter of claim 4, wherein the different indices of refraction differ by an amount in the range of about 0.5 to 1.5 and have a ratio of about 1.0 to 2.0.

6. The optical attenuation filter of claim 1, wherein the coating is comprised of a plurality of layers, and wherein the composition of at least one layer is identical to the composition of at least another layer.

7. The optical attenuation filter of claim 1, wherein each of the at least one dielectric material is selected from the group consisting of at least one oxide material, at least one non-oxide material, at least one glass, at least one ceramic and at least one polymer.

8. The optical attenuation filter of claim 7, wherein each of the at least one oxide material is selected from the group consisting of silicon dioxide, tantalum pentoxide, titanium dioxide and aluminum oxide.

9. The optical attenuation filter of claim 7, wherein each of the at least one non-oxide material is selected from the group consisting of zinc sulfide, zinc selenide, cryolite, lead fluoride, thorium fluoride and magnesium fluoride.

10. The optical attenuation filter of claim 1, wherein the substrate is a transparent glass or glass-like material.

11. The optical attenuation filter of claim 10, wherein the substrate is selected from the group consisting of fused silica, borosilicate, BK7, soda-lime glass and crown glass.

12. The optical attenuation filter of claim 1, further comprising:
a sealant applied atop at least a portion of the coating, wherein the presence of the sealant is effective to render the coating less susceptible to environmental degradation.

13. An optical attenuation filter, comprising:
a substrate; and
a coating having at least one layer, the coating including at least two different dielectric materials such that the filter is capable of attenuating incident light via reflectance, wherein the at least two different dielectric materials have different indices of refraction that differ by a predetermined amount and have a predetermined ratio such that the optical attenuation filter is capable of attenuating a varying amount of incident light based on variation of an angle between the optical attenuation filter and the incident light.

14. The optical attenuation filter of claim 13, wherein the different indices of refraction differ by an amount in the range of about 0.5 to 1.5 and have a ratio of about 1.0 to 2.0.

15. The optical attenuation filter of claim 13, wherein at least one of the at least two different dielectric materials is selected from the group consisting of at least one oxide material, at least one non-oxide material, at least one glass, at least one ceramic and at least one polymer.

16. The optical attenuation filter of claim 15, wherein the at least one oxide material is selected from the group consisting of silicon dioxide, tantalum pentoxide, titanium dioxide and aluminum oxide.

17. The optical attenuation filter of claim 15, wherein the at least one non-oxide material is selected from the group consisting of zinc sulfide, zinc selenide, cryolite, lead fluoride, thorium fluoride and magnesium fluoride.

18. A method of forming an optical attenuation filter, comprising the steps of:
providing a substrate; and
introducing a coating having at least one layer atop at least a portion of the substrate, the coating including at least one dielectric material such that the filter is capable of attenuating incident light via reflectance.

19. The method of claim 18, wherein the step of introducing the coating atop at least a portion of the substrate is accomplished by at least one technique selected from the group consisting of chemical vapor deposition, physical vapor deposition, thermal evaporation, ion assisted deposition, ion beam sputtering, magnetic sputtering, and reactive ion plating.

20. The method of claim 18, further comprising the step of:
introducing a sealant atop at least a portion of the coating, wherein the presence of the sealant is effective to render the coating less susceptible to environmental degradation.

21. The optical attenuation filter of claim 18, wherein the coating includes at least two different dielectric materials.

22. The optical attenuation filter of claim 21, wherein the coating includes a plurality of layers, and wherein at least a first of the plurality of layers includes a first dielectric material, and wherein the at least a second of the plurality of layers includes a second dielectric material that is different from the first dielectric material.

23. The optical attenuation filter of claim 21, wherein the different dielectric materials have different indices of refraction, and wherein the indices of refraction differ by a predetermined amount and have a predetermined ratio such that the optical attenuation filter is capable of attenuating a varying amount of incident light based on variation of an angle between the optical attenuation filter and the incident light.

24. The optical attenuation filter of claim 23, wherein the different indices of refraction differ by an amount in the range of about 0.5 to 1.5 and have a ratio of about 1.0 to 2.0.

25. A method of utilizing an optical attenuation filter to attenuate light from a light source, comprising the steps of:
providing an optical attenuation filter having a coating, wherein the coating includes at least one dielectric material and has at least one layer;
directing output from a light source toward the optical attenuation filter; and
causing the optical attenuation filter to be rotated about its vertical axis such that an angle between the optical attenuation filter and the light source is at least partially varied and such that the amount of output from the light source that is attenuated by the optical attenuation filter varies based on variation of the angle.

26. The method of claim 25, wherein the step of causing the optical attenuation filter to be rotated about its vertical axis is accomplished by:
placing the optical attenuation filter into communication with an object such that the filter is capable of being rotated about its vertical axis; and
rotating the object to cause rotation of the optical attenuation filter about the vertical axis of the optical attenuation filter.

27. The method of claim 26, wherein the object is a mounting frame.

28. The method of claim 25, wherein the coating includes at least two different dielectric materials.

29. The optical attenuation filter of claim 28, wherein the coating includes a plurality of layers, and wherein at least a first of the plurality of layers includes a first dielectric material, and wherein the at least a second of the plurality of layers includes a second dielectric material that is different from the first dielectric material.

30. The optical attenuation filter of claim 28, wherein the different dielectric materials have different indices of refraction, and wherein the indices of refraction differ by a predetermined amount and have a predetermined ratio such that the optical attenuation filter is capable of attenuating a varying amount of output based on variation of an angle between the optical attenuation filter and the output.

31. The optical attenuation filter of claim 26, wherein the coating is comprised of a plurality of layers, and wherein the composition of at least one layer is identical to the composition of at least another layer.

32. The optical attenuation filter of claim 26, wherein each of the at least one dielectric material is selected from the group consisting of at least one oxide material, at least one non-oxide material, at least one glass, at least one ceramic and at least one polymer.

33. The optical attenuation filter of claim 32, wherein each of the at least one oxide material is selected from the group consisting of silicon dioxide, tantalum pentoxide, titanium dioxide and aluminum oxide.

34. The optical attenuation filter of claim 32, wherein each of the at least one non-oxide material is selected from the group consisting of zinc sulfide, zinc selenide, cryolite, lead fluoride, thorium fluoride and magnesium fluoride.
